(19) United States
(12) Patent Application Publication
(10) Pub. No.: US 2019/0180010 A1
(43) Pub. Date: Jun. 13, 2019

(54) STORAGE DEVICE PERFORMING SECURE DEBUGGING AND PASSWORD AUTHENTICATION METHOD THEREOF

(71) Applicant: SAMSUNG ELECTRONICS CO., LTD., Suwon-si (KR)

(72) Inventor: Suengchul RYU, Hwaseong-si (KR)

(73) Assignee: SAMSUNG ELECTRONICS CO., LTD., Suwon-si (KR)

(21) Appl. No.: 16/050,778

(22) Filed: Jul. 31, 2018

(30) Foreign Application Priority Data
Dec. 13, 2017 (KR) 10-2017-0171451

(51) Int. Cl. G06F 21/31; G06F 21/46; G06F 21/74; H04L 9/32; G06F 11/14

(52) U.S. Cl. CPC G06F 21/31; G06F 21/46; G06F 11/1441; H04L 9/3226; G06F 21/74

(57) ABSTRACT

A storage device is provided. The storage device is connected to a debugging host and includes a nonvolatile memory device; a storage controller configured to control the nonvolatile memory device; and a secure debugging manager configured to count a number of times that a password input from the debugging host and a registered password are mismatched and to block access of the debugging host based on the number of times reaching a threshold count, the storage controller being further configured to store the number of times in the nonvolatile memory device and provide the number of times to the secure debugging manager.

### CROSS-REFERENCE TO RELATED APPLICATION

This application claims priority under 35 U.S.C. § 119 from Korean Patent Application No. 10-2017-0171451, filed on Dec. 13, 2017, in the Korean Intellectual Property Office, the disclosure of which is hereby incorporated by reference in its entirety.

### BACKGROUND

Methods and apparatuses consistent with example embodiments relate to a semiconductor memory device, and in particular, to a storage device performing secure debugging and a password authentication method thereof.

A flash memory device is used as a storage media to store data, such as voice and image data, in information devices such as a computer, a smartphone, a personal digital assistant (PDA), a digital camera, a camcorder, a voice recorder, an MP3 player, a handheld PC, and the like. An example of a flash memory based mass storage device is a solid state drive (hereinafter referred to as “SSD”). The SSD may be categorized as a SSD for server, a SSD for client, a SSD for data center, and the like. The SSD for the above-described uses may be managed and maintained to provide high reliability and optimized quality of service.

Recently, attacks through a storage device debugging channel have increased, and an attack technology has also advanced. As such, security requirements for storage products have also increased. In particular, because a Joint Test Action Group (JTAG) port provides a high degree of controllability and observability for storage products, secure debugging technology to protect the JTAG port has been actively researched. The authentication scheme of a secure debugging system includes a password authentication scheme and a challenge-response authentication scheme. A password authentication scheme is vulnerable to a reply attack. When the complexity of the password is low, it is likely that a dictionary attack or a brute-force attack will expose the password.

There is an urgent need for a technique capable of neutralizing the above-described dictionary attack or brute-force attack in a system-on-a-chip (SoC) or an embedded system in addition to a storage device using a password authentication scheme.

### SUMMARY

Example embodiments provide a storage device having a secure debugging device that neutralizes a password attack and a password authentication method thereof.

According to an aspect of an example embodiment, there is provided a storage device that is connected to a debugging host, the storage device including: a nonvolatile memory device; a storage controller configured to control the nonvolatile memory device; and a secure debugging manager configured to count a number of times that a password input from the debugging host and a registered password are mismatched and to block access of the debugging host based on the number of times reaching a threshold count, the storage controller being further configured to store the number of times in the nonvolatile memory device and provide the number of times to the secure debugging manager.

According to an aspect of another example embodiment, there is provided a password authentication method of a storage device having a debugging channel, the password authentication method including: receiving a password through the debugging channel from a debugging host; comparing the password with a registered password stored in the storage device; increasing a mismatch count based on a mismatch of the password and the registered password; determining whether the mismatch count has reached a threshold count; and disabling the debugging channel of the storage device based on the mismatch count reaching the threshold count.

According to an aspect of yet another example embodiment, there is provided a storage device including: a nonvolatile memory device; and a storage controller configured to control the nonvolatile memory device. The storage controller includes: a main channel interface configured to interface with a first host; a debugging channel interface configured to interface with a second host independently of the main channel interface; a nonvolatile memory interface configured to access the nonvolatile memory device based on a request of the first host or the second host; and a finite authentication logic configured to determine an error count corresponding to a second host password mismatch, and disable the debugging channel interface based on the error count.

### BRIEF DESCRIPTION OF THE FIGURES

The above and other objects and features will become apparent from the following description with reference to the figures, wherein like reference numerals refer to like parts throughout the various figures unless otherwise specified.

FIG. 1 is a block diagram illustrating a storage device and a debugging host, according to an example embodiment;

FIG. 2 is a flowchart illustrating a password authentication procedure between a debugging host and a storage device according to an example embodiment;

FIG. 3 is a block diagram illustrating a configuration of a secure debugging manager according to an example embodiment;

FIG. 4 is a block diagram illustrating a detailed configuration of finite authentication logic according to an example embodiment;

FIG. 5 is a block diagram schematically illustrating operation of a password generator according to an example embodiment;

FIG. 6 is a block diagram illustrating a configuration of a secure debugging manager, according to another example embodiment;

FIG. 7 is a flowchart illustrating the finite password authentication operation of a secure debugging manager, according to an example embodiment;

FIG. 8 is a flowchart illustrating a detailed operation of a secure debugging manager, according to an example embodiment;

FIG. 9 is a flowchart illustrating a method of managing a mismatch count value when reset of a storage device occurs, according to an example embodiment;

FIG. 10 is a flowchart illustrating an example of a method for restarting a disabled storage device by finite authentication logic, according to an example embodiment; and

FIG. 11 is a block diagram schematically illustrating a solid state drive to which a finite password authentication scheme is applied, according to an example embodiment.

### DETAILED DESCRIPTION

It is to be understood that both the foregoing general description and the following detailed description are provided for illustration of example embodiments, and not for limiting the scope of the present disclosure. Reference numerals will be represented in detail in example embodiments, examples of which are illustrated in the accompanying drawings. Wherever possible, the same reference numerals are used in the drawings and the description to refer to the same or similar parts.

Below, a solid state drive using a flash memory device will be exemplified as an electronic device or a storage device. However, one skilled in the art may easily understand other merits and performance of the inventive concept depending on the contents disclosed here. The inventive concept may be implemented or applied through other example embodiments. In addition, the detailed description may be changed or modified according to view points and applications without departing from the claims, the scope and spirit, and any other purposes of the inventive concept.

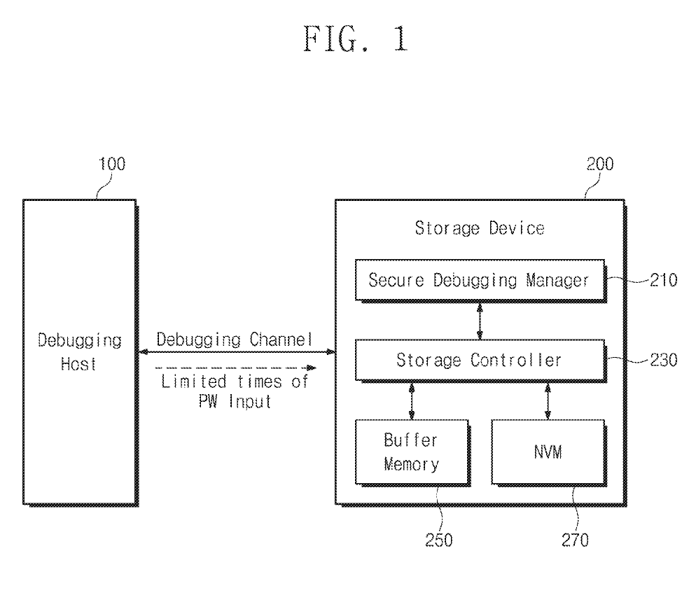

FIG. 1 is a block diagram illustrating a storage device and a debugging host, according to an example embodiment. Referring to FIG. 1, the number of password inputs to a storage device 200 from a debugging host 100 connected through a debugging channel may be limited.

The debugging host 100 may write data in the storage device 200 or may read data stored in the storage device 200. The debugging host 100 may generate a command for a debugging operation to write data in the storage device 200 or to read data stored in the storage device 200. The debugging host 100 may be a debugging tool such as a personal computer or a server.

The debugging host 100 may detect a failure or an error of the storage device 200 and may have a function to extract dump data. If an error or a failure event occurs, the debugging host 100 requests the storage device 200 to collect and store dump data for debugging, through a debugging channel. In addition, if the storage of the dump data is completed, the debugging host 100 may read the stored dump data from the storage device 200. The debugging host 100 may analyze the read dump data to recognize the state or the error of the storage device 200.

The storage device 200 provides data requested by the debugging host 100 and stores data write-requested by the debugging host 100. In particular, if various errors or problems occur, the storage device 200 generates dump data including the state information of the storage device 200 at a point in time when an error occurs, and stores the dump data in a buffer memory 250 or a nonvolatile memory (NVM) device 270. The dump data includes error context or failure context. The storage device 200 may transmit the stored dump data stored in the buffer memory 250 or the nonvolatile memory device 270 to the debugging host 100.

In particular, the storage device 200 is connected to the debugging host 100 through the debugging channel. Unlike a general channel provided for data exchange, the debugging channel has more powerful control authority of the storage device 200. For example, the debugging host 100 accessing the storage device 200 through the debugging channel may stop or resume the operation of the storage device 200. Because the state and log information of hardware and software, such as dump data, needs to be read out, the technology information of the storage device 200 may be easily deduced through the debugging host 100 accessing the debugging channel. Accordingly, access via the debugging channel uses a secure debugging scheme that only allows access of the debugging host 100 when authenticated through a password. However, when a brute-force attack using various parallel processing schemes is used, there is also a limit to the authentication scheme using the password.

The storage device 200 according to an example embodiment may apply a finite password authentication scheme for limiting the number of password inputs to the debugging host 100 attempting to attack. To this end, the storage device 200 according to an example embodiment may include a secure debugging manager 210, a storage controller 230, the buffer memory 250, and the nonvolatile memory device 270.

The secure debugging manager 210 may perform password-based authentication on the debugging host 100 connected to the debugging channel. If the debugging host 100 is connected to the storage device 200, the secure debugging manager 210 may make a request for a password to the debugging host 100. The secure debugging manager 210 compares the input password PWi provided from the debugging host 100 with the previously stored registration password PWr. If it is determined that the input password PWi matches the registration password PWr, the secure debugging manager 210 allows the debugging host 100 to access the storage device 200. On the other hand, if it is determined that the input password PWi mismatches the registration password PWr, the secure debugging manager 210 temporarily blocks access of the debugging host 100 to the storage device 200 and requests the debugging host 100 to re-input the password. If the password PWi provided by the debugging host 100 is not matched within a limited count, the secure debugging manager 210 may permanently block access to the debugging host 100. The configuration or function of the secure debugging manager 210 will be described in detail with reference to the following accompanying drawings.

The storage controller 230 is controlled by the debugging host 100 depending on the authentication result of the secure debugging manager 210. If password authentication by the secure debugging manager 210 is successful, the storage controller 230 may output data that the debugging host 100 requests. That is, the storage controller 230 may provide user data or dump data stored in the buffer memory 250 or the nonvolatile memory device 270, to the debugging host 100 depending on the password authentication result. In particular, the storage controller 230 may update a password mismatch count PWMM_CNT in the nonvolatile memory device 270, under control of the secure debugging manager 210. Furthermore, the storage controller 230 may provide the password mismatch count PWMM_CNT stored in the nonvolatile memory device 270 to the secure debugging manager 210, under control of the secure debugging manager 210.

The buffer memory 250 may be the buffer of the storage device 200. The buffer memory 250 may temporarily store data to be written in the nonvolatile memory device 270 or data read from the nonvolatile memory device 270. The buffer memory 250 may be, for example, a dynamic random access memory (DRAM).

The nonvolatile memory device 270 may be a storage medium where data write-requested by the debugging host 100 is finally stored. Moreover, the number of times that the input password PWi provided by the debugging host 100 mismatches the registration password PWr is stored in the nonvolatile memory device 270. Hereinafter, the number of times that the input password PWi mismatches the registration password PWr is referred to as a “password mismatch count PWMM_CNT”. Furthermore, the nonvolatile memory device 270 may provide the password mismatch count PWMM_CNT to the secure debugging manager 210 in a state where the storage device 200 is reset or initialized.

If the input password PWi provided by the debugging host 100 connected to the debugging channel is mismatched a number of times corresponding to the limited count, the storage device 200 according to an example embodiment may permanently block access through the debugging channel. Accordingly, the password brute-force attack to the storage device 200 through the debugging channel may be neutralized.

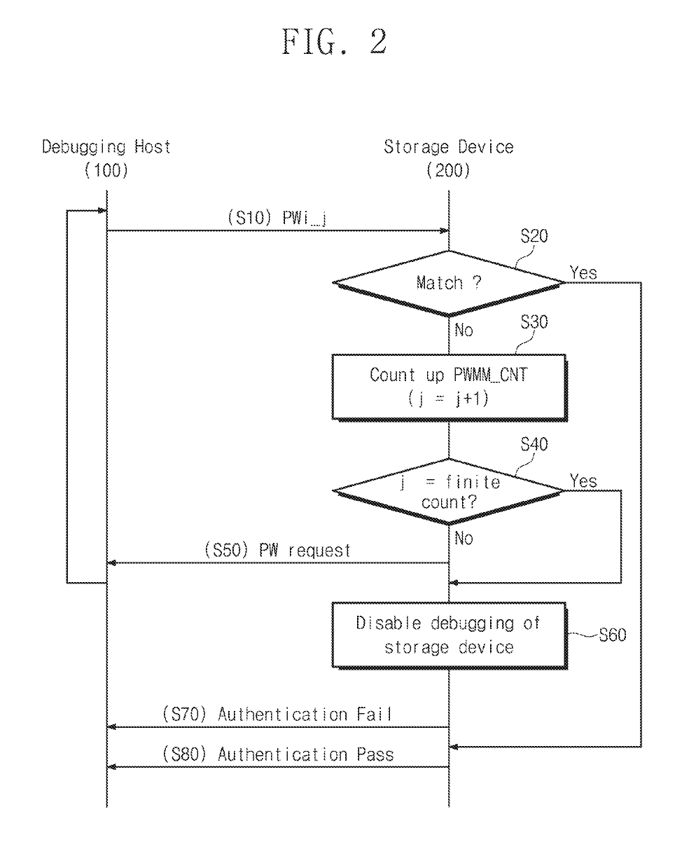

FIG. 2 is a flowchart illustrating a password authentication procedure between a debugging host and a storage device in FIG. 1. Referring to FIG. 2, the debugging host 100 may input the input password PWi in the storage device 200 for a limited count. If a password that matches the registration password PWr is not input within the limited count (hereinafter called a “finite count”), the debugging channel of the storage device 200 may be permanently disabled.

In operation S10, the debugging host 100 is connected to the storage device 200 through the debugging channel, and the debugging host 100 transmits an input password PWi_j (‘j’ is an integer that is not less than ‘0’) to the storage device 200.

In operation S20, the storage device 200 may determine whether the input password PWi provided by the debugging host 100 matches the registration password PWr registered in the storage device 200. If it is determined that the input password PWi matches the registration password PWr, the procedure proceeds in the Yes direction to operation S80. In operation S80, the storage device 200 notifies the debugging host 100 that authentication is successful and permits access of debugging host 100. On the other hand, if it is determined that the input password PWi mismatches the registration password PWr, the procedure proceeds in the No direction to operation S30.

In operation S30, the storage device 200 increases a mismatch count PWMM_CNT, which corresponds to the number of times that the input password PWi mismatches the registration password PWr. That is, if the mismatch between the passwords PWi and PWr in operation S20 corresponds to the first mismatch, the storage device 200 increases a mismatch count PWMM_CNT (‘j’=‘0’) to ‘j=0+1’. Afterwards, the procedure may proceed to step S40.

In operation S40, whether the value j of the increased mismatch count PWMM_CNT matches a finite count value is checked. The finite count is a value stored in the storage device 200 depending on a security attribute. If it is determined that the value T of the increased mismatch count PWMM_CNT is less than the finite count value, the procedure proceeds in the No direction to operation S50. That is, in operation S50, the storage controller 230 requests the debugging host 100 to input an additional password. Moreover, the procedure returns to operation S10 of receiving the input password PWi_j that is input by the debugging host 100 again. On the other hand, if it is determined that the value ‘j’ of the increased mismatch count PWMM_CNT has reached the finite count value, the procedure proceeds in the Yes direction to operation S60.

In operation S60, the storage device 200 completely blocks access from the outside through the debugging channel. For example, the storage device 200 may permanently block access of the debugging host 100 currently connected to the debugging channel. Afterwards, the procedure may proceed to step S70.

In operation S70, the storage device 200 transmits a message to debugging host 100 indicating that authentication has failed.

An operation of the storage device 200 performing finite password authentication according to an example embodiment is above described briefly. When the number of times that the password PWi provided by the debugging host 100 attempting to authenticate is mismatched reaches the finite count, access of the debugging host 100 is blocked. Accordingly, the storage device 200 according to an example embodiment may neutralize the password-based brute-force attack. In addition, the security of the debugging channel of the storage device 200 may be greatly improved.

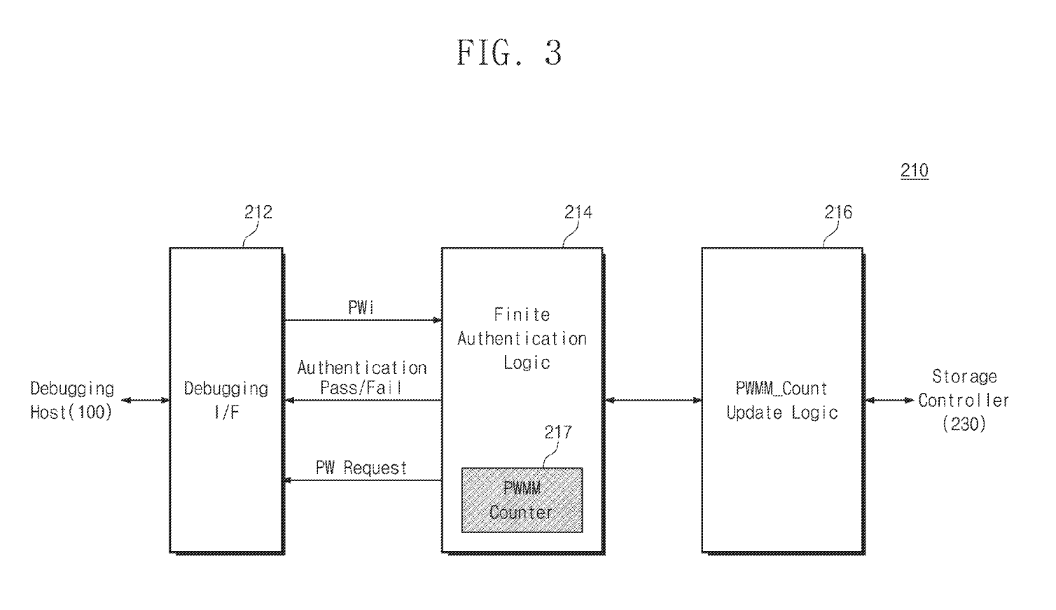

FIG. 3 is a block diagram illustrating a configuration of a secure debugging manager according to an example embodiment. Referring to FIG. 3, the secure debugging manager 210 may include a debugging interface 212, finite authentication logic 214, and mismatch count update logic 216.

The debugging interface 212 may provide an interface between the debugging host 100 and the storage device 200. The debugging interface 212 may further include a protocol converter that transmits a command or an address, provided by the debugging host 100, to the storage controller 230. The debugging interface 212 may transmit the input password PWi, which the debugging host 100 inputs, to the finite authentication logic 214. Furthermore, the debugging interface 212 may transmit a message indicating authentication pass or authentication fail, which the finite authentication logic 214 transmits, to the debugging host 100.

For example, the debugging interface 212 may be an interface using a protocol such as JTAG or a serial wire scheme. An inter-integrated circuit (I²C) interface is an example of an interface using a serial wire protocol. However, the debugging interface 212 may be replaced with various protocols such as a system management bus (SMBus), a universal asynchronous receiver transmitter (UART), a serial peripheral interface (SPI), a high-speed inter-chip (HSIC), and the like.

The finite authentication logic 214 may perform an authentication procedure on the debugging host 100 based on a password. In particular, the finite authentication logic 214 detects whether the input password PWi provided by the debugging host 100 matches the registration password PWr stored therein. In particular, the finite authentication logic 214 counts the mismatch count PWMM_CNT between the input password PWi and the registration password PWr. If the mismatch count PWMM_CNT is less than the finite count, the finite authentication logic 214 may make a request for password re-input PW request to the debugging host 100. Moreover, if the counted mismatch count PWMM_CNT has reached the finite count, the finite authentication logic 214 blocks access of the debugging host 100 providing the input password PWi. Alternatively, if the counted mismatch count PWMM_CNT has reached the finite count, the finite authentication logic 214 may permanently block access through the debugging channel. That is, the finite authentication logic 214 may limit the number of times that the debugging host 100 inputs a password. To this end, the finite authentication logic 214 may include a mismatch count counter 217.

The mismatch count counter 217 counts the mismatch count PWMM_CNT between the input password PWi that the identified debugging host 100 inputs and the registration password PWr. In addition, the mismatch count counter 217 may transmit the counted mismatch count PWMM_CNT to the mismatch count update logic 216. In the case, the mismatch count PWMM_CNT is updated in the nonvolatile memory device 270 by the mismatch count update logic 216 in real time. Moreover, in a situation of a power reset or an initialization operation, the mismatch count counter 217 may restore the mismatch count PWMM_CNT to the most recently updated value. That is, even if a power reset POR occurs, the mismatch count PWMM_CNT stored in the nonvolatile memory device 270 in real time is read out. Accordingly, the mismatch count PWMM_CNT may be restored to the value before the power reset POR.

The mismatch count update logic 216 updates the mismatch count PWMM_CNT counted by the mismatch count counter 217, in the nonvolatile memory device 270 in real time. Also, if power reset or initialization occurs, the mismatch count update logic 216 reads out the mismatch count PWMM_CNT updated from the nonvolatile memory device 270 to provide the mismatch count PWMM_CNT to the mismatch count counter 217. The mismatch count PWMM_CNT between the input password PWi and the registration password PWr is updated by the mismatch count update logic 216 in real time. In addition, to defend a password attack or even though an unintended power reset or initialization has occurred, the mismatch count update logic 216 allows the mismatch count PWMM_CNT to be maintained as the most recent value. To this end, the mismatch count update logic 216 may directly control the storage controller 230.

Above, configuration of the secure debugging manager 210 according to an example embodiment is described briefly. However, the above-described configuration is an example, and various changes for updating and managing the mismatch count PWMM_CNT in real time are possible.

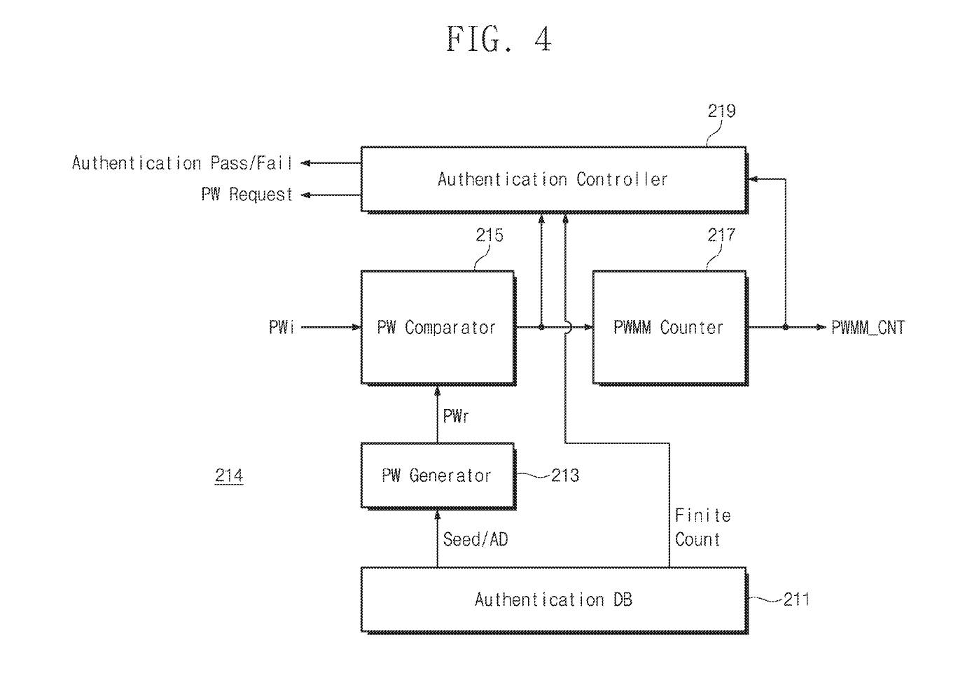

FIG. 4 is a block diagram illustrating a detailed configuration of finite authentication logic according to an example embodiment. Referring to FIG. 4, the finite authentication logic 214 may include an authentication database (DB) 211, a password generator 213, a password comparator 215, the mismatch count counter 217, and an authentication controller 219.

The authentication DB 211 stores a registration password PWr, a seed for generating a registration password, and the value of a finite count Finite count. Depending on the method of generating the registration password PWr, the authentication DB 211 may store the seed Seed for generating the registration password PWr or authentication data AD. The seed Seed may be a constant value or specific data corresponding to the registration password PWr. For example, the seed Seed may use unique ID information of a memory or storage medium such as the nonvolatile memory device 270 or the buffer memory 250. Alternatively, the seed Seed may be a value input by the provider or vendor of the storage device 200. The value of the finite count Finite count stored in the authentication DB 211 may be programmed to various values depending on a security level. That is, a lower value may be used as the finite count for a high security level, whereas a higher value may be used as the finite count for a lower security level. The authentication DB 211 may be implemented with a programmable fuse or a read only memory (ROM).

The password generator 213 generates the registration password PWr by using the seed Seed or the authentication data AD provided from the authentication DB 211. The password generator 213 may perform a password generating operation using the seed Seed. The password generator 213 may be a circuit or an algorithm that generates a pseudo random binary sequence (hereinafter referred to as a “PRBS”) depending on the seed Seed. For example, the password generator 213 may perform a sequence generating algorithm (e.g., SHA-1 or SHA-0) of a hash function method or an algorithm generating a random sequence. It will be understood that the method in which the password generator 213 generates the registration password PWr is not limited thereto.

The password comparator 215 compares the input password PWi provided by the debugging host 100 with the registration password PWr. The password comparator 215 may provide each of the authentication controller 219 and the mismatch count counter 217 with the comparison result between the input password PWi and the registration password PWr.

The mismatch count counter 217 accumulates and counts the mismatch count PWMM_CNT between the input password PWi and the registration password PWr. Furthermore, the mismatch count counter 217 determines whether the counted mismatch count PWMM_CNT has reached the finite count Finite count. For example, if it is detected that the input password PWi provided first by the password comparator 215 matches the registration password PWr, the mismatch count counter 217 maintains the mismatch count PWMM_CNT as ‘0’. On the other hand, if it is detected that the input password PWi provided first by the password comparator 215 mismatches the registration password PWr, the mismatch count counter 217 increases the mismatch count PWMM_CNT from ‘0’ to ‘1’. Moreover, the mismatch count counter 217 may control the storage controller 230 such that the increased mismatch count PWMM_CNT ‘1’ is stored in the nonvolatile memory device 270. Furthermore, the mismatch count counter 217 transmits the increased mismatch count PWMM_CNT to the authentication controller 219 to determine whether to continue the authentication procedure.

The authentication controller 219 transmits authentication success/failure Authentication Pass/Fail or password re-input request PW request to the debugging host 100, with reference to the comparison result of passwords and the mismatch count PWMM_CNT. If it is determined by the password comparator 215 that the input password PWi matches the registration password PWr, the authentication controller 219 determines the authentication success Authentication Pass. In addition, the authentication controller 219 may permit the debugging host 100 to freely access the storage device 200.

On the other hand, if it is determined by the password comparator 215 that the input password PWi mismatches the registration password PWr, the authentication controller 219 determines whether the mismatch count PWMM_CNT has reached the finite count Finite count. If the mismatch count PWMM_CNT is less than the finite count Finite count even though the input password PWi mismatches the registration password PWr, the authentication controller 219 transmits a password request PW request to the debugging host 100 such that the debugging host 100 re-inputs a password. On the other hand, if the input password PWi mismatches the registration password PWr and it is determined that the mismatch count PWMM_CNT has reached the finite count Finite count, the authentication controller 219 determines authentication failure Authentication Fail. Afterwards, the authentication controller 219 transmits an authentication failure message to the debugging host 100 and completely blocks access of the debugging host 100 to the storage device 200.

The security function of a finite password input method of the storage device 200 according to an example embodiment may be provided by the configuration and the function of the finite authentication logic 214.

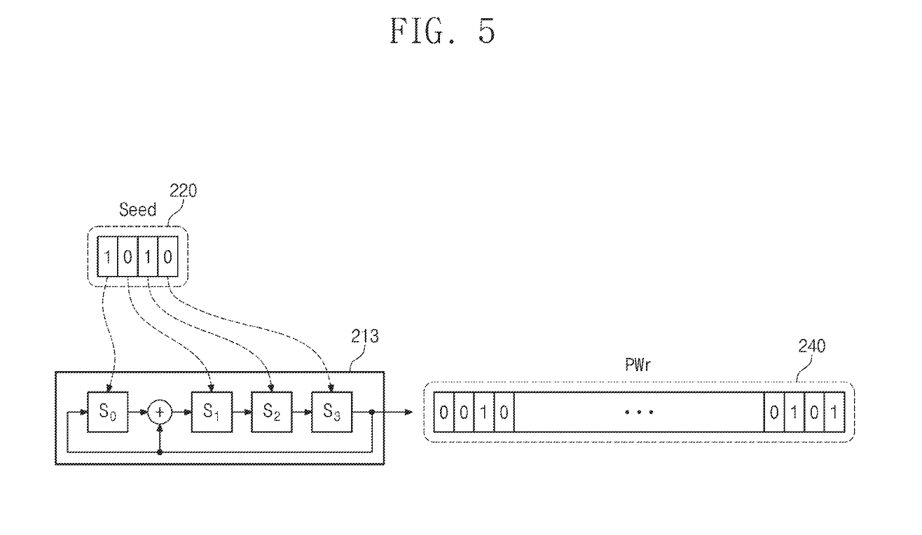

FIG. 5 is a block diagram schematically illustrating an operation of a password generator according to an example embodiment. Referring to FIG. 5, the registration password PWr may be generated in a random sequence generating method using the seed Seed. The security may be improved by generating and managing the registration password PWr.

As illustrated, the password generator 213 may be implemented with a sequence generator including a shift register and an exclusive-OR (XOR) operator. The seed Seed may be generated as the registration password PWr of the extended length by a linear feedback shift register (LFSR) including a plurality of flip-flops S₀, S₁, S₂, and S₃. For example, if a seed 220 of 4-bits is provided, ‘1010’ may be loaded onto the flip-flops S₀, S₁, S₂, and S₃ of the password generator 213. In addition, a bit string 240 output as a clock cycle increases may be provided as the registration password PWr.

The configuration of the above-described password generator 213 is illustrative, and the registered password PWr may be generated through various types of operators or algorithms using the seed Seed.

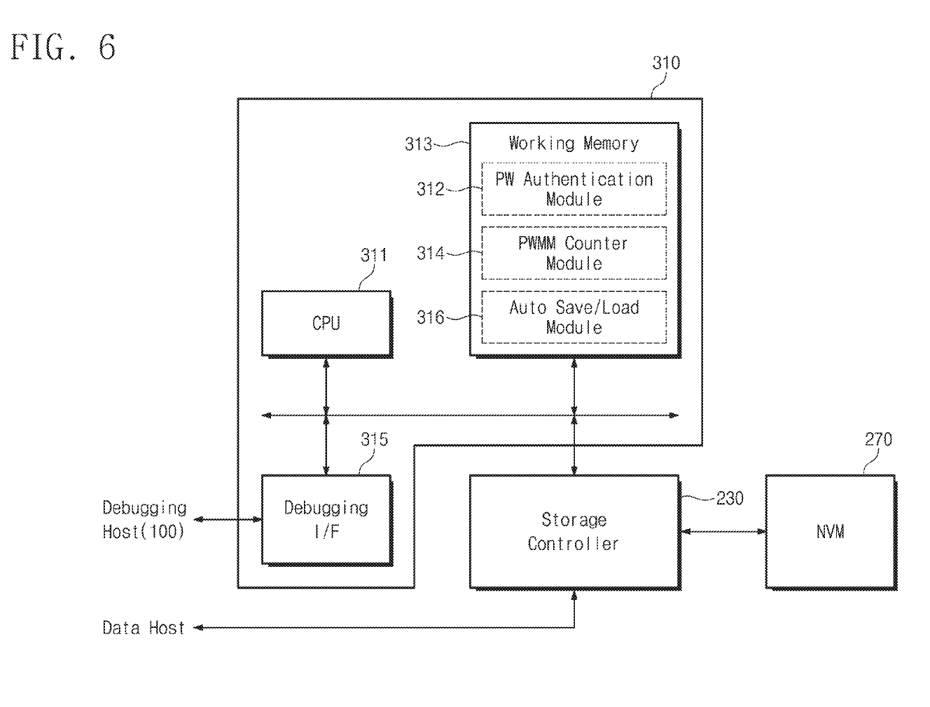

FIG. 6 is a block diagram illustrating a configuration of a secure debugging manager, according to another example embodiment. Referring to FIG. 6, a secure debugging manager 310 may operate software modules 312, 314, and 316 performing the function of the finite authentication logic 214. To this end, the secure debugging manager 310 may include a central processing unit 311, a working memory 313, and a debugging interface 315.

The central processing unit 311 may execute the software modules 312, 314, and 316 loaded onto the working memory 313, for finite password authentication according to an example embodiment. The password authentication module 312 detects whether the input password PWi provided by the debugging host 100 matches the registration password PWr stored therein. The mismatch count counter module 314 counts the mismatch count PWMM_CNT between the input password PWi and the registration password PWr. In addition, whenever the counted mismatch count PWMM_CNT is changed, the mismatch count counter module 314 transmits the counted mismatch count PWMM_CNT to the auto save/load module 316. The mismatch count PWMM_CNT is updated in the nonvolatile memory device 270 via the storage controller 230 in real time by the auto save/load module 316. Moreover, in a situation of a power reset or an initialization operation, the mismatch count counter module 314 may restore the mismatch count PWMM_CNT to the most recently updated value. That is, even though power reset POR occurs, the mismatch count counter module 314 may read and continuously manage the mismatch count PWMM_CNT stored in the nonvolatile memory device 270 in real time.

In particular, if the counted mismatch count PWMM_CNT is less than the finite count, the password authentication module 312 may make a request for password re-input PW request to the debugging host 100. Moreover, if the counted mismatch count PWMM_CNT has reached the finite count, the password authentication module 312 blocks access of the debugging host 100. Alternatively, if the counted mismatch count PWMM_CNT has reached the finite count, the password authentication module 312 may permanently block access through the debugging channel. That is, the password authentication module 312 may limit the number of times that the debugging host 100 inputs a password, to a finite count.

The debugging interface 315 may further include a protocol converter to transmit a command or an address, which are provided by the debugging host 100, to the storage controller 230. The debugging interface 315 may transmit the input password PWi, which the debugging host 100 inputs, to the central processing unit 311 executing the password authentication module 312. Furthermore, the debugging interface 315 may transmit a message indicating authentication pass Authentication pass or authentication failure Authentication fail which the password authentication module 312 provides, to the debugging host 100.

The operation of the secure debugging manager 310 provided for debugging may be performed independently of the control of a data host connected to the storage controller 230. The detailed operation of the secure debugging manager 310 is similar to the operation of the secure debugging manager 210 of FIG. 2 or 3 described above. However, the secure debugging manager 310 shows that the configurations of the secure debugging manager 210 of FIG. 2 or 3 are capable of being implemented with a software module.

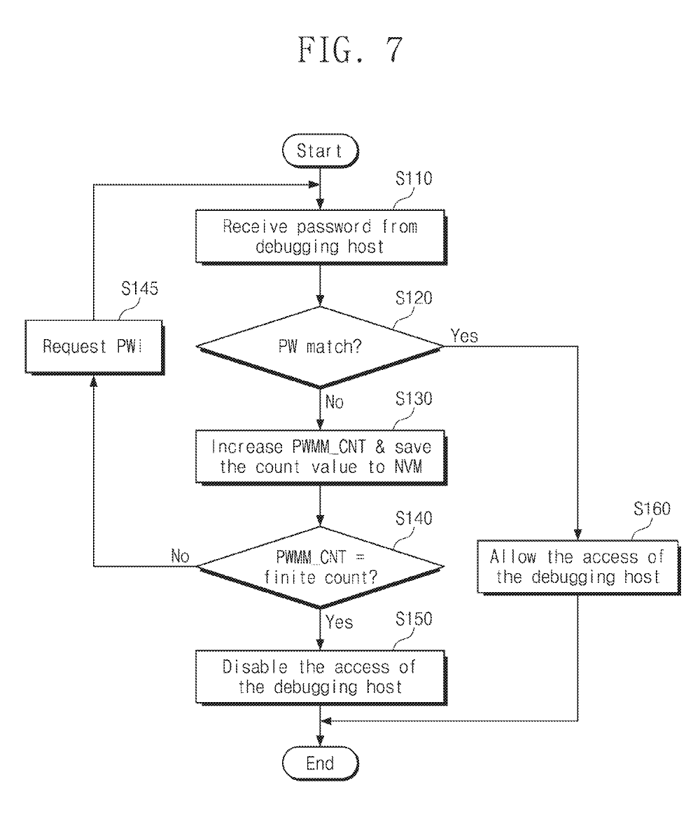

FIG. 7 is a flowchart illustrating a finite password authentication operation of the secure debugging manager 210, according to an example embodiment. Referring to FIG. 7, if the mismatch count PWMM_CNT has reached the finite count Finite count, the secure debugging manager 210 blocks access through a debugging channel.

In operation S110, the secure debugging manager 210 identifies the debugging host 100 and receives the input password PWi that the debugging host 100 inputs. In addition, the secure debugging manager 210 may receive the input password PWi by using a method of transmitting a password request PW request at a point in time when the debugging host 100 is connected to the storage device 200 by using the debugging channel.

In operation S120, the secure debugging manager 210 detects whether the input password PWi provided by the debugging host 100 matches the registration password PWr stored therein. That is, in this operation, the comparison result, which is provided by the password comparator 215 (refer to FIG. 4), between the input password PWi and the registration password PWr may be used. If it is determined that the input password PWi matches the registration password PWr, the procedure proceeds in the Yes direction to operation S160. On the other hand, if it is determined that the input password PWi mismatches the registration password PWr, the procedure proceeds in the No direction to operation S130.

In operation S130, the mismatch count PWMM_CNT is increased, and the increased mismatch count PWMM_CNT is stored in the storage device 200.

In operation S140, whether the mismatch count PWMM_CNT has reached the finite count Finite count, which is determined depending on a security attribute, is determined by the authentication controller 219 (refer to FIG. 4). If the mismatch count PWMM_CNT is not the same as the finite count Finite count, the procedure proceeds in the No direction to operation S145 to make a request for the password re-input PW request to the debugging host 100. Afterwards, the procedure returns to operation S110 to receive a password again. On the other hand, if the counted mismatch count PWMM_CNT is the same as the value of the finite count Finite count, the procedure proceeds in the Yes direction to operation S150.

In operation S150, the authentication controller 219 blocks the overall access to the storage device 200 using the debugging channel. If a correct password is not input within the finite count Finite count, the authentication controller 219 may permanently prohibit access to the storage device 200 through the debugging channel. Alternatively, the authentication controller 219 may permanently prohibit access of only the identified debugging host 100.

In operation S160, the authentication controller 219 allows access to the storage device 200 using the debugging channel of the debugging host 100 that has succeeded in authentication.

Above, operation of the secure debugging manager 210 according to an example embodiment is described briefly. The secure debugging manager 210 according to an example embodiment may neutralize the brute-force attack of a password such as a dictionary attack, by limiting the password input opportunity of the debugging host 100 connected to the debugging channel.

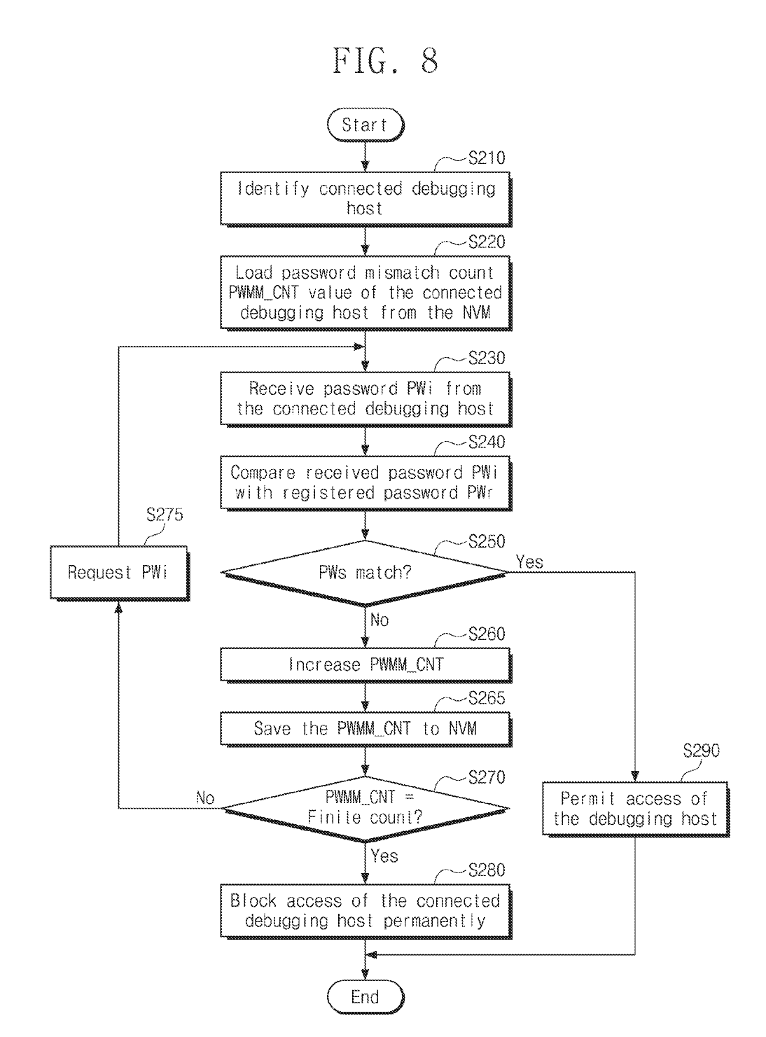

FIG. 8 is a flowchart illustrating a detailed operation of a secure debugging manager, according to an example embodiment. Referring to FIG. 8, the secure debugging manager 210 may count a number of password input errors by the debugging host 100 to manage access using a debugging channel.

In operation S210, the secure debugging manager 210 identifies the debugging host 100. For example, if the debugging host 100 is connected to the storage device 200 by using the debugging channel, the secure debugging manager 210 may request identification information of the debugging host 100. For example, the secure debugging manager 210 may request the ID of the debugging host 100. Alternatively, the secure debugging manager 210 may recognize the connection of the debugging host 100 by using the identification information that the connected debugging host 100 automatically transmits.

In operation S220, the secure debugging manager 210 may load the mismatch count PWMM_CNT associated with the identified debugging host 100. For example, the mismatch count update logic 216 (refer to FIG. 3) may load the mismatch count PWMM_CNT read from the nonvolatile memory device 270, onto the mismatch count counter 217.

In operation S230, the secure debugging manager 210 receives the input password PWi that the debugging host 100 inputs. The received input password PWi may be provided to the password comparator 215.

In operation S240, the password comparator 215 compares the input password PWi with the registration password PWr. The value generated in advance from the seed Seed by the password generator 213 may be used as the registration password PWr.

In operation S250, an operation branch occurs depending on the result of comparison between the input password PWi and the registration password PWr by the password comparator 215. If it is determined that the input password PWi matches the registration password PWr, the procedure proceeds in the Yes direction to operation S290. On the other hand, if it is determined that the input password PWi mismatches the registration password PWr, the procedure proceeds in the No direction to operation S260.

In operation S260, the mismatch count PWMM_CNT between the input password PWi and the registration password PWr is increased by the mismatch count counter 217. The mismatch count counter 217 increases the mismatch count PWMM_CNT loaded in operation S220, by ‘1’.

In operation S265, the mismatch count update logic 216 may save the increased mismatch count PWMM_CNT in the storage device 200.

In operation S270, whether the mismatch count PWMM_CNT has reached the finite count Finite count, determined depending on a security attribute, is determined by the authentication controller 219 (refer to FIG. 4). If the mismatch count PWMM_CNT is not the same as the finite count Finite count, the procedure proceeds in the No direction to operation S275 to make a request for the password re-input PW request to the debugging host 100. Afterwards, the procedure returns to operation S230 to receive a password. On the other hand, if the counted mismatch count PWMM_CNT is the same as the finite count Finite count, the procedure proceeds in the Yes direction to operation S280.

In operation S280, the authentication controller 219 blocks overall access to the storage device 200 using the debugging channel. If a correct password is not input within the finite count Finite count, the authentication controller 219 may permanently prohibit access to the storage device 200 through the debugging channel. Alternatively, the authentication controller 219 may disable the operation of the storage device 200 itself.

In operation S290, the authentication controller 219 permits access to the storage device 200 using the debugging channel for the debugging host 100 that has succeeded in authentication.

According to the above-described procedure, the secure debugging manager 210 according to an example embodiment counts an error of the password and blocks access to the storage device 200 using the debugging channel.

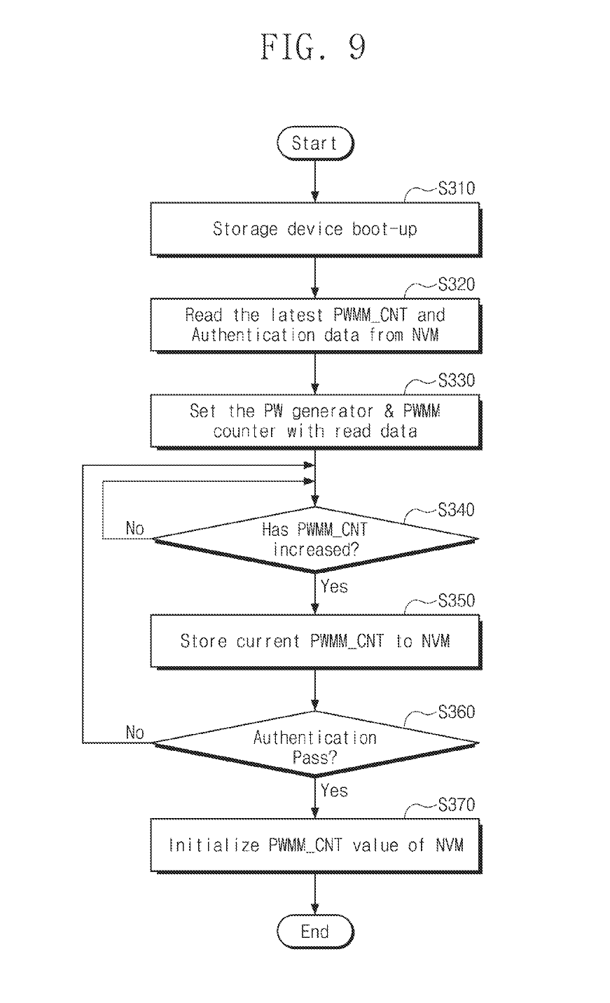

FIG. 9 is a flowchart illustrating a method of managing a mismatch count value when a storage device reset occurs, according to an example embodiment. Referring to FIG. 9, even if a debugging host 100 attempts a power reset for the purpose of initializing the mismatch count of a password, a value which is the same as the mismatch count PWMM_CNT before the reset may be loaded onto the mismatch count counter 217 according to an example embodiment. Accordingly, the dictionary attack against the password may be disabled.

In operation S310, the storage device 200 may be booted up again by power reset or initialization. The finite authentication logic 214 may recognize the reset or the initialization.

In operation S320, the mismatch count update logic 216 reads the mismatch count PWMM_CNT stored in the nonvolatile memory device 270. Moreover, the mismatch count update logic 216 may update various pieces of authentication information as well as the mismatch count PWMM_CNT in the nonvolatile memory device 270 and may read the various pieces of authentication information during a reset operation to set the secure debugging manager 210.

In operation S330, the mismatch count update logic 216 may set the mismatch count counter 217 by using the mismatch count PWMM_CNT read from the nonvolatile memory device 270. Accordingly, the mismatch count PWMM_CNT value set in the mismatch count counter 217 is restored to the previous value before reset. In addition, the mismatch count update logic 216 may set the password generator 213 by using pieces of authentication information read from the nonvolatile memory device 270.

In operation S340, the mismatch count update logic 216 detects whether the mismatch count PWMM_CNT has increased, from the mismatch count counter 217. If it is detected that the mismatch count PWMM_CNT has increased, the procedure proceeds in the Yes direction to operation S350. On the other hand, if an increase in the mismatch count PWMM_CNT is not detected, the mismatch count update logic 216 continuously monitors whether the mismatch count PWMM_CNT increases.

In operation S350, the mismatch count update logic 216 stores the increased mismatch count PWMM_CNT in the nonvolatile memory device 270. The change in the mismatch count PWMM_CNT may be monitored by the mismatch count update logic 216 in real time, and the changed mismatch count PWMM_CNT value may be updated in the nonvolatile memory device 270 in real time.

If authentication success is detected in operation S360 by the debugging host 100 using a password, the mismatch count update logic 216 may initialize (or reset) the mismatch count PWMM_CNT. On the other hand, when authentication of the debugging host 100 fails, the procedure returns to operation S340.

In operation S370, because the password authentication of the debugging host 100 is successful, the mismatch count update logic 216 initializes, or resets, the mismatch count PWMM_CNT.

Above, operation of the mismatch count update logic 216 for the finite password authentication operation according to an example embodiment is exemplarily described. The mismatch count update logic 216 stores the mismatch count PWMM_CNT of a password in the nonvolatile memory device 270 in real time, and may read and restore the mismatch count PWMM_CNT stored in the nonvolatile memory device 270 during a reset operation. Accordingly, the secure debugging manager 210 may disable an attempt to initialize the mismatch count PWMM_CNT by triggering a power reset or an initialization operation.

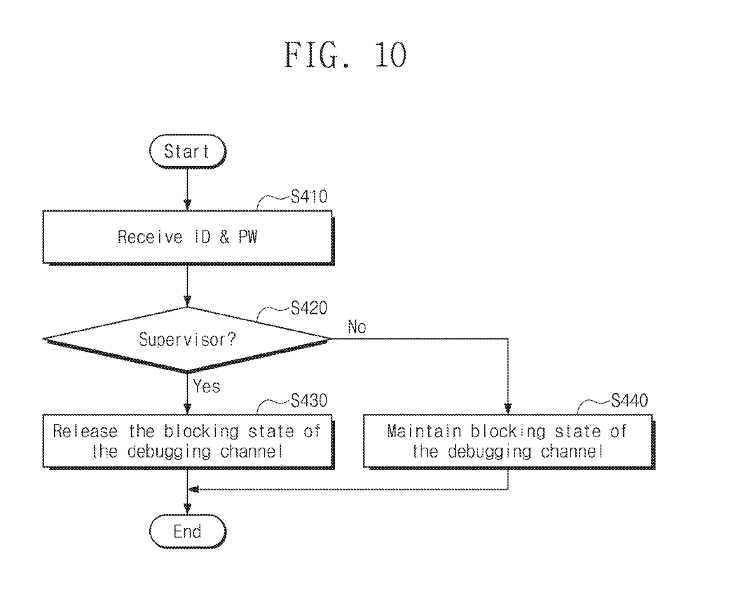

FIG. 10 is a flowchart illustrating an example of a method for restarting a disabled storage device by finite authentication logic, according to an example embodiment. Referring to FIG. 10, the storage device 200 disabled due to the excess of the mismatch count of password may be recovered by the specific supervisor.

In operation S410, power may be applied to the storage device 200 whose access is blocked, and a host may be connected to a debugging channel. In this case, the storage device 200 may make a request for an identification ID and a password PW to the host.

In operation S420, the storage device 200 may determine whether the identification ID and the password PW correspond to a supervisor having authority to restart the storage device 200. If the identification ID and the password PW match the identification ID and the password PW of the supervisor, the procedure proceeds to operation S430. On the other hand, if the input identification ID and the password PW mismatch the identification ID and the password PW of the supervisor, the procedure proceeds to operation S440.

In operation S430, the storage device 200 releases access blocking and assigns access authority to the host.

In operation S440, the storage device 200 recognizes that the input identification ID and the password PW corresponds to the host that do not have the authority to restart, and maintains the access blocking state.

Above, a method of restarting the disabled storage device 200 according to an example embodiment is described. However, the secure debugging manager 210 of the storage device 200 may be designed such that there is no restart opportunity depending on the security level.

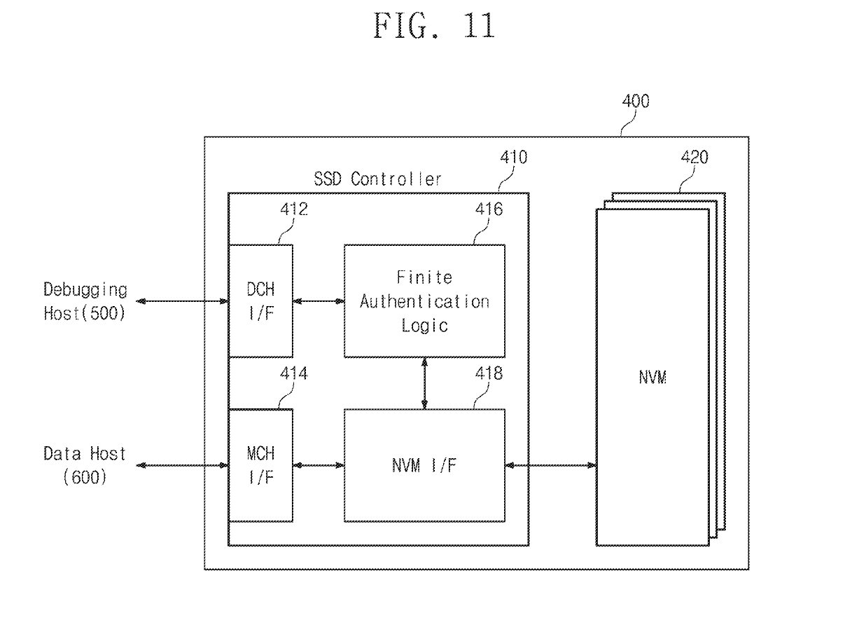

FIG. 11 is a block diagram schematically illustrating a solid state drive (hereinafter referred to as a “SSD”) to which a finite password authentication scheme is applied, according to an example embodiment. Referring to FIG. 11, a solid state drive 400 may include an SSD controller 410 and a nonvolatile memory device 420.

The SSD controller 410 may include channel interfaces 412 and 414 that operate independently. The debugging channel interface 412 may provide an interface between a debugging host 500 and the solid state drive 400. The main channel interface 414 may provide an interface with a data host 600 using the solid state drive 400 as storage.

Finite authentication logic 416 may block or permit access of the debugging host 500 by applying a finite password authentication scheme that limits password input count. The finite authentication logic 416 may perform a password-based authentication operation the same as the operation of the above-described secure debugging manager 210 of FIG. 1. Thus, a detailed description about the operation of the finite authentication logic 416 will not be repeated.

The NVM interface 418 exchanges data with the nonvolatile memory device 420. The NVM interface 418 may transmit read data from the nonvolatile memory device 420, to the data host 600 or the finite authentication logic 416. In particular, under control of the finite authentication logic 416, the NVM interface 418 may store the password error count of the debugging host 500, in the nonvolatile memory device 420 in real time.

The nonvolatile memory device 420 may include, for example, a flash memory. The nonvolatile memory device 420 may be implemented with nonvolatile memory elements such as electrically erasable and programmable ROM (EEPROM), NAND flash memory, NOR flash memory, phase-change RAM (PRAM), resistive RAM (ReRAM), ferroelectric RAM (FRAM), spin-torque magnetic RAM (STT-MRAM), and the like. For convenience of description, it may be assumed that the nonvolatile memory device 270 includes a NAND flash memory.

In an example embodiment, according to an example embodiment, the nonvolatile memory device 420 may include a three-dimensional memory array. The three-dimensional memory array may be monolithically formed in one or more physical levels of a memory cell array having an active area arranged on a circuit related on a silicon substrate and an operation of memory cells. The circuit related to an operation of memory cells may be located in a substrate or on a substrate. The term “monolithic” means that layers of each level of the array are directly deposited on the layers of each underlying level of the array.

According to an example embodiment, the three-dimensional memory array may have a vertical-directional characteristic, and may include vertical NAND strings in which at least one memory cell is located on another memory cell. The at least one memory cell may include a charge trap layer. Each vertical NAND string may include at least one selection transistor located over memory cells. At least one selection transistor may have the same structure as those of memory cells and may be monolithically formed together with memory cells.

The following patent documents, which are hereby incorporated by reference in their entireties, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and US Pat. Pub. No. 2011/0233648.

According to an example embodiment, the password attack times of a storage device or an electronic device through a debugging channel may be limited. That is, it is possible to neutralize an authentication attempt such as a brute-force attack through a password by limiting the number of password input times. Accordingly, a storage device according to an example embodiment may provide high security against a password attack through the debugging channel.

The various operations of methods described above may be performed by any suitable means capable of performing the operations, such as various hardware and/or software components, circuits, and/or modules.

The software may include an ordered listing of executable instructions for implementing logical functions, and can be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

As described above, example embodiments are disclosed in the drawings and specifications. Here, the terminology used herein is for the purpose of describing particular example embodiments only and is not intended to limit the present disclosure. Therefore, those skilled in the art will appreciate that various modifications and other equivalent embodiments are possible. The scope of the present disclosure will be defined by the scope of the appended claims and their equivalents.

What is claimed is:

1. A storage device configured to connect to a debugging host, the storage device comprising:
a nonvolatile memory device;
a storage controller configured to control the nonvolatile memory device; and
a secure debugging manager configured to count a number of times that a password input from the debugging host and a registered password are mismatched and to block access of the debugging host based on the number of times reaching a threshold count,
wherein the storage controller is further configured to store the number of times in the nonvolatile memory device and provide the number of times to the secure debugging manager.

2. The storage device of claim 1, wherein the secure debugging manager is further configured to read the number of times stored in the nonvolatile memory device to perform password authentication, in a power reset or initialization situation.

3. The storage device of claim 1, wherein the secure debugging manager comprises:
a finite authentication logic configured to count the number of times; and
a mismatch count update logic configured to control the storage controller to store the number of times in the nonvolatile memory device in real time.

4. The storage device of claim 3, wherein the finite authentication logic comprises:
a password comparator configured to compare the registered password with the password input from the debugging host;
a mismatch count counter configured to accumulate a password comparison result to count the number of times that the password input from the debugging host and the registered password are mismatched; and
an authentication controller configured to determine that authentication of the debugging host fails based on the number of times reaching the threshold count.

5. The storage device of claim 4, wherein the secure debugging manager further comprises a debugging interface configured to interface with the debugging host, and
wherein the authentication controller is further configured to disable access through the debugging interface based on the authentication controller determining that the authentication of the debugging host failed.

6. The storage device of claim 5, wherein the debugging interface is further configured to use at least one protocol from among a joint test action group (JTAG), an inter-integrated circuit (I²C) interface, a system management bus (SMBus), a universal asynchronous receiver transmitter (UART), a serial peripheral interface (SPI), and a high-speed inter-chip (HSIC).

7. The storage device of claim 4, wherein the finite authentication logic further comprises:
an authentication database configured to store a seed for generating the registered password and the threshold count; and
a password generator configured to generate the registered password by using the seed.

8. A password authentication method of a storage device having a debugging channel, the password authentication method comprising:
receiving a password through the debugging channel from a debugging host;
comparing the password with a registered password stored in the storage device;
increasing a mismatch count based on a mismatch of the password and the registered password;
determining whether the mismatch count has reached a threshold count; and
disabling the debugging channel of the storage device based on the mismatch count reaching the threshold count.

9. The password authentication method of claim 8, further comprising storing the mismatch count in a nonvolatile memory device.

10. The password authentication method of claim 9, further comprising reading the mismatch count stored in the nonvolatile memory device if power of the storage device is reset.

11. The password authentication method of claim 9, further comprising initializing the mismatch count stored in the nonvolatile memory device based on the password received matching the registered password in the comparing of the password and the registered password.

12. The password authentication method of claim 8, further comprising making a request to the debugging host for a new password based on the mismatch count not reaching the threshold count.

13. The password authentication method of claim 12, further comprising generating the registered password based on a seed stored in the storage device.

14. The password authentication method of claim 13, wherein the seed is extracted from identification (ID) information of a nonvolatile memory device.

15. A storage device comprising:
a nonvolatile memory device; and
a storage controller configured to control the nonvolatile memory device,
wherein the storage controller comprises:
a main channel interface configured to interface with a first host;
a debugging channel interface configured to interface with a second host independently of the main channel interface;
a nonvolatile memory interface configured to access the nonvolatile memory device based on a request of the first host or the second host; and
a finite authentication logic configured to determine an error count corresponding to a second host password mismatch, and disable the debugging channel interface based on the error count.

16. The storage device of claim 15, wherein the finite authentication logic is further configured to update the error count in the nonvolatile memory device in real time.

17. The storage device of claim 16, wherein the finite authentication logic is further configured to read the error count from the nonvolatile memory device in response to a reset of the storage controller.

18. The storage device of claim 17, wherein the finite authentication logic is further configured to initialize the error count stored in the nonvolatile memory device based on the second host successfully authenticating with the storage controller.

19. The storage device of claim 15, wherein the finite authentication logic is further configured to compare a registered password with a password received from the second host to count the error count.

20. The storage device of claim 15, wherein the debugging channel interface is a joint test action group (JTAG) or a serial wire interface protocol.
